(19) United States
(12) Patent Application Publication
(10) Pub. No.: US 2009/0190382 A1
(43) Pub. Date: Jul. 30, 2009

(54) POWER FACTOR CORRECTING CONVERTER

(75) Inventor: Hiroshi USUI, Niiza-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sanken Electric Co., Ltd., Niiza-shi (JP)

(21) Appl. No.: 12/355,136

(22) Filed: Jan. 16, 2009

(30) Foreign Application Priority Data
Jan. 24, 2008 (JP) 2008-013970

(51) Int. Cl. H02M 7/12

(52) U.S. Cl. 363/89

(57) ABSTRACT

A power factor correcting converter includes a rectifier to rectify an AC voltage of an AC power source into a pulsating voltage, a voltage converter having a switching element, to convert the pulsating voltage into a predetermined DC voltage with the switching element being turned on/off according to a control signal, an smoothing circuit to smooth the control signal, and a control signal generator to generate the control signal and change a switching frequency of the control signal according to an output from the smoothing circuit.

### BACKGROUND OF THE INVENTION

1. Field of the Invention

The present invention relates to a power factor correcting converter.

2. Description of the Related Art

FIG. 1 is a circuit diagram illustrating a power factor correcting converter according to a related art. In FIG. 1, a bridge rectifier (diode bridge) DB receives an AC voltage Vin through a noise filter 11 and rectifies the same. The rectified output from the bridge rectifier DB is supplied through a normal mode filter C1 to a step-up chopper that includes a reactor L1, a switching element Q1 made of a MOSFET, a diode D1, and a capacitor C4. The switching element Q1 is tuned on/off according to a control signal from a controller, so that the capacitor C4 of the step-up chopper provides a stepped-up output voltage Vout.

The controller includes a current-output-type operational amplifier 13, a multiplier 15, a current detecting operational amplifier 17, an oscillator (OSC) 19, a PWM comparator 23, an inverter (INV) 21, an RS flip-flop 25, and an AND gate 27. The AND gate 27 outputs a control signal F to the switching element Q1.

The step-up chopper and controller constitute a step-up-chopper-type active filter. This active filter is a current continuous active filter in which the switching frequency of the switching element Q1 is fixed, PWM control is carried out, and a direct current is superimposed on a current passing through the reactor L1 depending on input/output conditions.

To make an input current waveform similar to a sinusoidal input voltage waveform, the active filter detects the input voltage waveform and uses the same as a target sinusoidal current waveform.

In the example of FIG. 1, an input voltage from the capacitor C1 is detected by series-connected resistors R1 and R2. The detected input voltage is applied to an input terminal C of the multiplier 15. The output voltage Vout is detected by resistors R8 and R9. The detected output voltage Vout is compared with a reference voltage Vref by the operational amplifier 13, which amplifies an error voltage between the compared voltages and supplies the amplified error voltage through a phase compensator to an input terminal D of the multiplier 15. The phase compensator consists of capacitors C6 and C7 and a resistor R7.

The multiplier 15 is of a current output type. The multiplier 15 multiplies the amplified error voltage from the operational amplifier 13 by the input voltage from a connection point of the resistors R1 and R2 and provides an output signal E to an inverting input terminal of the operational amplifier 17. Namely, the magnitude of the error signal based on the output voltage Vout determines the magnitude of the target sinusoidal current.

The operational amplifier 17 compares the output signal E from the multiplier 15, i.e., a target switching current with a switching current detected by a resistor R4, amplifies the difference, and provides an output signal J to an inverting input terminal of the PWM comparator 23.

The oscillator 19 is connected to a capacitor CT and a resistor RT. The capacitor CT and resistor RT determine the oscillation frequency of the oscillator 19 that determines a switching frequency.

The oscillator 19 charges and discharges the capacitor CT, to generate a triangular signal A as illustrated in the timing chart of FIG. 2, and according to the upper and lower limit values of the triangular signal A, generates a rectangular signal B. The triangular signal A is supplied to a non-inverting input terminal of the PWM comparator 23 and the rectangular signal B is supplied to a reset terminal R of the flip-flop 25 and the inverter 21.

If the triangular signal A from the oscillator 19 is equal to or larger than the output signal J from the operational amplifier 17, the PWM comparator 23 provides a high-level output to a set terminal of the flip-flop 25, and if the triangular signal A is smaller than the signal J, a low-level output to a set terminal S of the flip-flop 25.

Receiving a high-level output from the PWM comparator 23, the flip-flop 25 outputs, from an output terminal Q, a high-level signal to an input terminal of the AND gate 27. The flip-flop 25 is reset when receiving the rectangular signal B of the oscillator 19 at the reset terminal R and provides, from the output terminal Q, a low-level output to the input terminal of the AND gate 27. The inverter 21 inverts the rectangular signal B and outputs the inverted signal to the other input terminal of the AND gate 27.

The AND gate 27 performs AND operation of the output from the flip-flop 25 and the output from the inverter 21 and provides the result as the control signal F to the gate of the switching element Q1. According to the example illustrated in FIG. 2, the AND gate 27 provides a high level output in a period from t11 to t12 to the gate of the switching element Q1. When the rectangular signal B is high, a dead time is produced in which the switching element Q1 is always OFF.

According to the example of FIG. 2, the output signal J from the operational amplifier 17 gradually increases as time passes, and accordingly, high-level widths of the gate waveform of the switching element Q1 gradually narrow. As a result, the output voltage Vout becomes substantially constant, and at the same time, an input AC current corresponding to an output current substantially becomes sinusoidal, thereby correcting a power factor.

Devices connected to a commercial power source generate noises. Such noises, in particular, input feedback conducted noises are regulated according to various standards such as international CISPR, American FCC, European Community's EN55022, and JAPANESE VCCI. These noise standards regulate noise frequencies equal to or higher than 150 kHz.

Recent switching power sources used for DC-DC converters and PFCs (power factor correctors) employ high switching frequencies due to a requirement for miniaturization. For this, the switching frequency of the switching element Q1 employed by the related art of FIG. 1 is set to be equal to or higher than 150 kHz. As a result, the largest noise voltage is of the fundamental wave of a switching frequency of 150 kHz or hither among the input feedback conducted noises. The noise voltage of this frequency appears between AC input terminals of the bridge rectifier DB.

FIG. 3 is a circuit diagram illustrating a DC-DC converter according to another related art described in Japanese Patent No. 3456583.

According to this related art, a control circuit 109 includes a PWM modulator 112 and a frequency setter 115 connected to the PWM modulator 112. The PWM modulator 112 controls an ON/OFF ratio of an ON/OFF control signal VG applied to a control terminal of a switching element 105. A modulation unit 119 includes a series resistor 118 connected between an AC power source 101 and the frequency setter 115. Through the series resistor 118, an AC voltage from the AC power source 101 is applied to the frequency setter 115. The frequency of the ON/OFF control signal VG from the PWM modulator 112 is modulated according to the AC voltage from the AC power source 101.

Modulating the frequency of the ON/OFF control signal VG provided by the control circuit 109 according to the AC voltage from the AC power source 101 results in dispersing the frequency components of the ON/OFF control signal VG within a predetermined range. As a result, the frequency components of input feedback conducted noises having the frequencies of the ON/OFF control signal VG as main components disperse within a predetermined range, so that the noises of these frequencies may not be superposed on one another. This results in reducing noise voltages and the number of parts such as filters, simplifying a circuit design, and lowering manufacturing costs.

### SUMMARY OF THE INVENTION

Noise voltages appearing between the AC input terminals of the bridge rectifier DB of FIG. 1 are fed back to a commercial line and are conducted to other electronic devices connected to the commercial line, to cause malfunctions of these electronic devices.

To suppress such input feedback conducted noises to values specified in the various standards, the related art of FIG. 1 arranges many filters such as the filter 11 before and after the bridge rectifier DB. Namely, the related art of FIG. 1 employs many noise reducing parts such as filters, to complicate a circuit design and increase manufacturing costs.

There will be an idea to employ an exclusive low-frequency generator to modulate the frequency of the gate signal applied to the switching element Q1, to thereby drop the voltage levels of input feedback conducted noises. Such an exclusive low-frequency generator, however, increases costs.

According to the DC-DC converter of the related art illustrated in FIG. 3, the AC power source 101 supplies a voltage through diodes 116 and 117 and the resistor 118 to a frequency setting capacitor 114 for the PWM modulator 112. Accordingly, the additional modulation unit 119 including the diodes 116 and 117 and resistor 118 needs a high-voltage line pattern to be formed. This raises a need of securing sufficient creepage distances among parts and wires according to safety standards. This restricts circuit arrangements.

Further, the additional resistor 118 causes an input loss. A recent power saving tendency requires a power factor correcting converter to be stopped in a light load state, to minimize power consumption. In such circumstances, the resistor 118 always causes a loss.

According to the present invention, provided is a power factor correcting converter capable of reducing, at low cost, noise components contained in the switching frequency of a switching element and harmonics thereof and minimizing a loss.

An aspect of the present invention provides a power factor correcting converter including a rectifier configured to rectify an AC voltage of an AC power source into a pulsating voltage; a voltage converter having a switching element, configured to convert the pulsating voltage into a predetermined DC voltage with the switching element being turned on/off according to a control signal; an smoothing circuit configured to average the control signal; and a control signal generator configured to generate the control signal and change a switching frequency of the control signal according to an output from the smoothing circuit.

### BRIEF DESCRIPTION OF THE DRAWINGS

FIG. 1 is a circuit diagram illustrating a power factor correcting converter according to a related art;

FIG. 2 is a timing chart illustrating signals generated in the converter of FIG. 1;

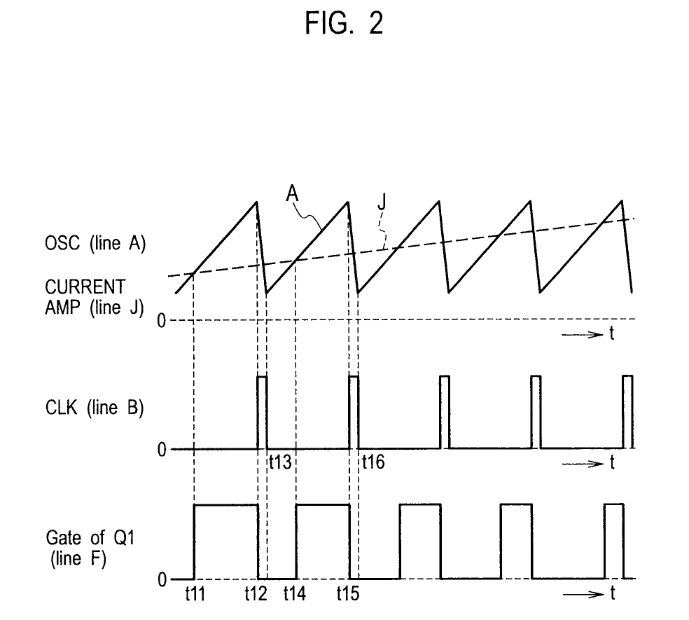

FIG. 3 is a circuit diagram illustrating a power factor correcting converter according to another related art;

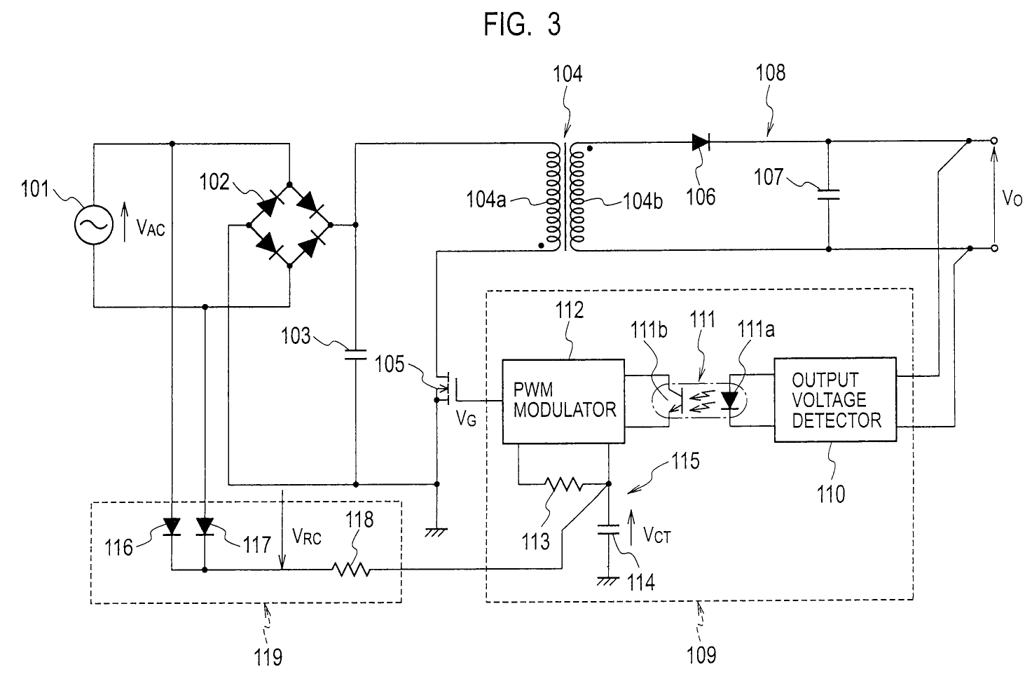

FIG. 4 is a circuit diagram illustrating a power factor correcting converter according to Embodiment 1 of the present invention;

FIG. 5 is a timing chart illustrating signals generated in the converter of FIG. 4;

FIG. 6 is a circuit diagram illustrating a power factor correcting converter according to Embodiment 2 of the present invention; and

FIG. 7 is a circuit diagram illustrating a power factor correcting converter according to Embodiment 3 of the present invention.

### DESCRIPTION OF THE PREFERRED EMBODIMENT

Power factor correcting converters according to embodiments of the present invention will be explained in detail with reference to the drawings.

### Embodiment 1

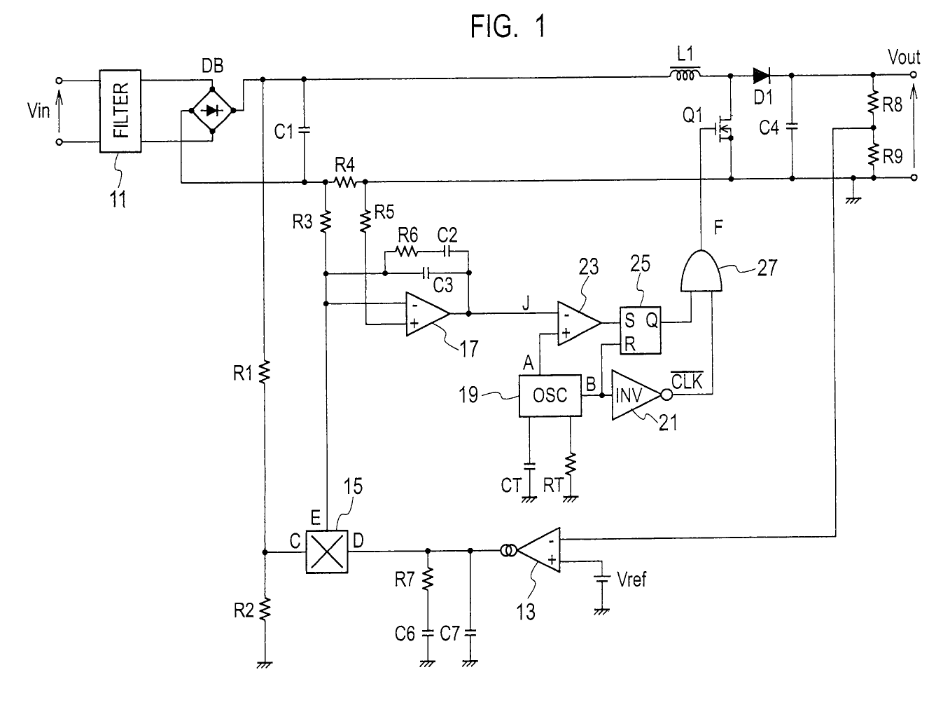

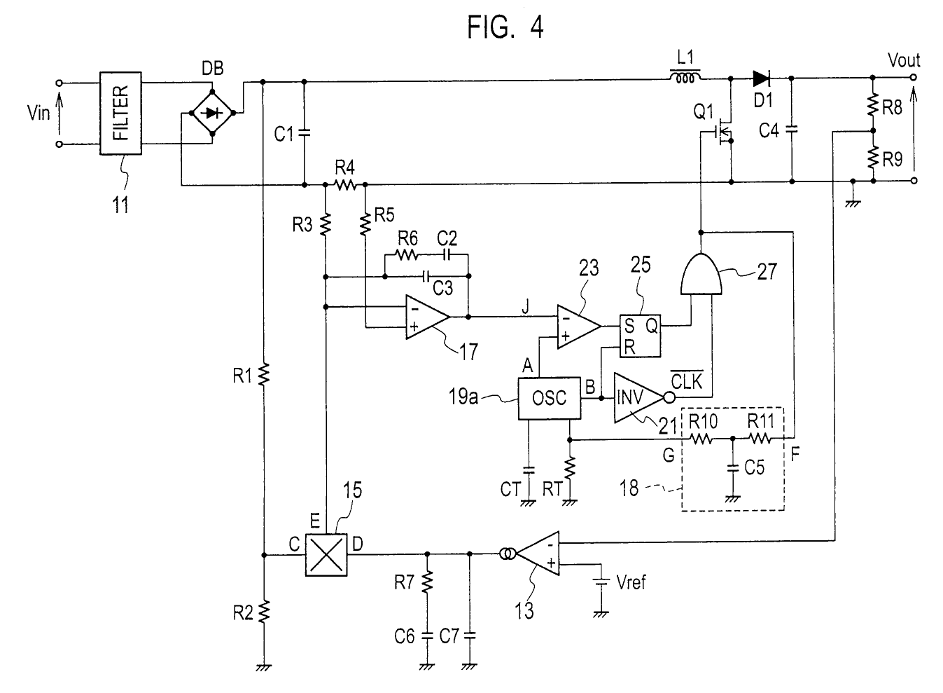

FIG. 4 is a circuit diagram illustrating a power factor correcting converter according to Embodiment 1 of the present invention. The present embodiment is characterized in that it employs a smoothing circuit 18 as an averaging element between the gate terminal of the switching element Q1, the output terminal (control signal F) of the AND gate 27, and the timing resistor RT of the oscillator 19 of the related art illustrated in FIG. 1.

The remaining parts of FIG. 4 are the same as those of FIG. 1, and therefore, the same parts are represented with the same reference marks to omit their detailed explanations. The configuration and operation of the smoothing circuit 18 of Embodiment 1 will be explained in detail.

In FIG. 4, the smoothing circuit 18 is connected between the gate terminal of a switching element Q1, the output terminal of an AND gate 27, and a timing resistor RT of an oscillator 19a. The smoothing circuit 18 includes a resistor (first impedance element) R10, a resistor (second impedance element) R11 connected in series with the resistor R10, and a capacitor (third impedance element) C5 connected between a connection point of the resistors R10 and R11 and the ground.

The smoothing circuit 18 smoothes a control signal applied to the switching element Q1 with the use of a CR filter consisting of the resistor R11 and capacitor C5 and outputs an averaged control signal G to the resistor RT of the oscillator 19a.

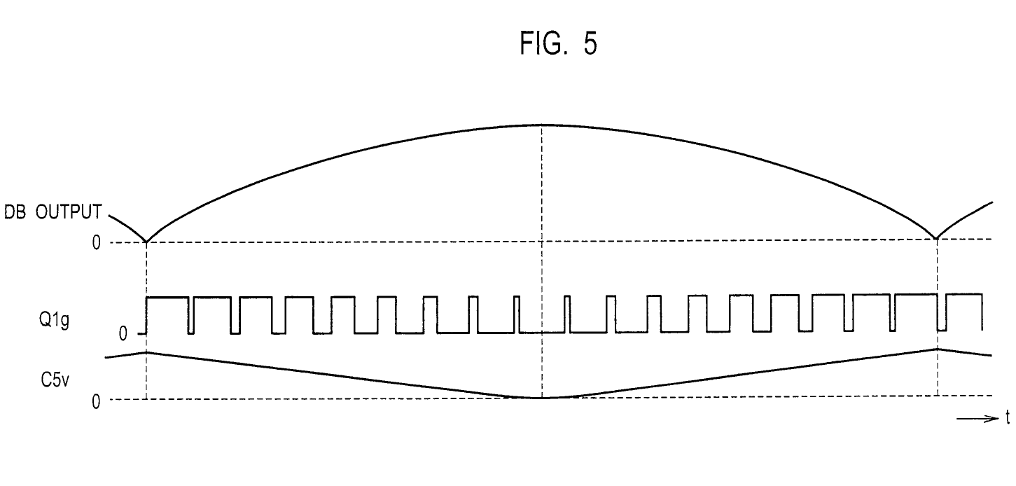

FIG. 5 is a timing chart illustrating signals generated in the power factor correcting converter of Embodiment 1. Operation of the smoothing circuit 18 will be explained with reference to FIG. 5.

To make an input current sinusoidal, a sinusoidal input voltage (depicted as “DB output” in FIG. 5) of a commercial frequency is detected by resistors R1 and R2. Based on the detected voltage, a multiplier 15, an operational amplifier 17, and a PWM comparator 23 generate a control signal Q1g applied to the switching element Q1.

The smoothing circuit 18 smoothes the control signal Q1g, to find a DC voltage from the sinusoidal input voltage of the commercial frequency, i.e., a voltage C5v of the capacitor C5. The voltage C5v is applied through the level adjusting resistor R10 to the timing resistor RT of the oscillator 19a. The voltage C5v applied to the timing resistor RT changes as illustrated in FIG. 5, and therefore, the oscillation frequency of the oscillator 19a changes accordingly. Namely, a frequency modulation is achieved according to the sinusoidal component of the commercial frequency.

As a result, the switching frequency of the switching element Q1 varies within a predetermined range, to disperse frequency components thereof within a predetermined range. Namely, the frequency components of input feedback conducted noises having the switching frequency as a main component are dispersed within a predetermined range, so that the noise voltages of these frequencies are not superposed on one another, thereby reducing noise voltage levels.

The present embodiment, therefore, can reduce the number of noise reducing parts such as filters, simplify a circuit design, and lower manufacturing costs. Further, the present embodiment can disperse harmonics related to the switching frequency, to minimize noises at low cost.

The smoothing circuit 18 of the present embodiment operates with a gate voltage of the switching element Q1, and therefore, consumes power only during the operation of the power factor correcting converter. Since the gate voltage is 1/10 to 1/20 of the input voltage, the present embodiment remarkably reduces power consumption with the smoothing circuit 18 operating on such a low voltage. Using the gate voltage of the switching element Q1 also minimizes creepage distances among parts and wires.

### Embodiment 2

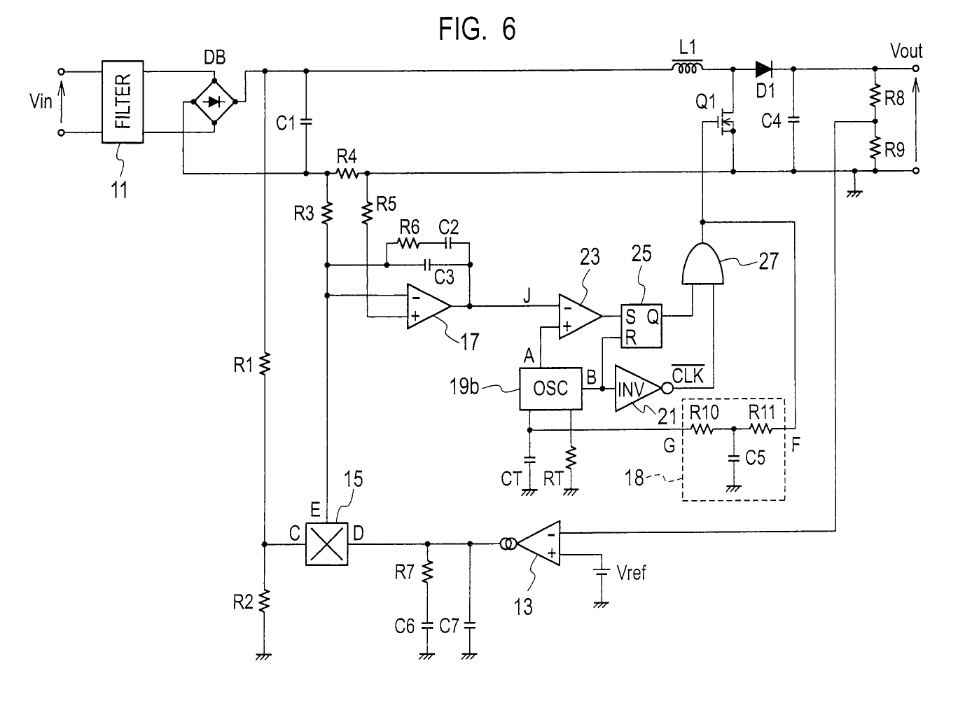

FIG. 6 is a circuit diagram illustrating a power factor correcting converter according to Embodiment 2 of the present invention. The present embodiment employs a smoothing circuit 18 composed of resistors R10 and R11 and a capacitor C5 with the resistor R10 connected to a capacitor CT of an oscillator 19b.

The smoothing circuit 18 of the present embodiment operates like that of Embodiment 1, and therefore, the power factor correcting converter of the present embodiment provides an effect similar to that provided by the power factor correcting converter of Embodiment 1.

### Embodiment 3

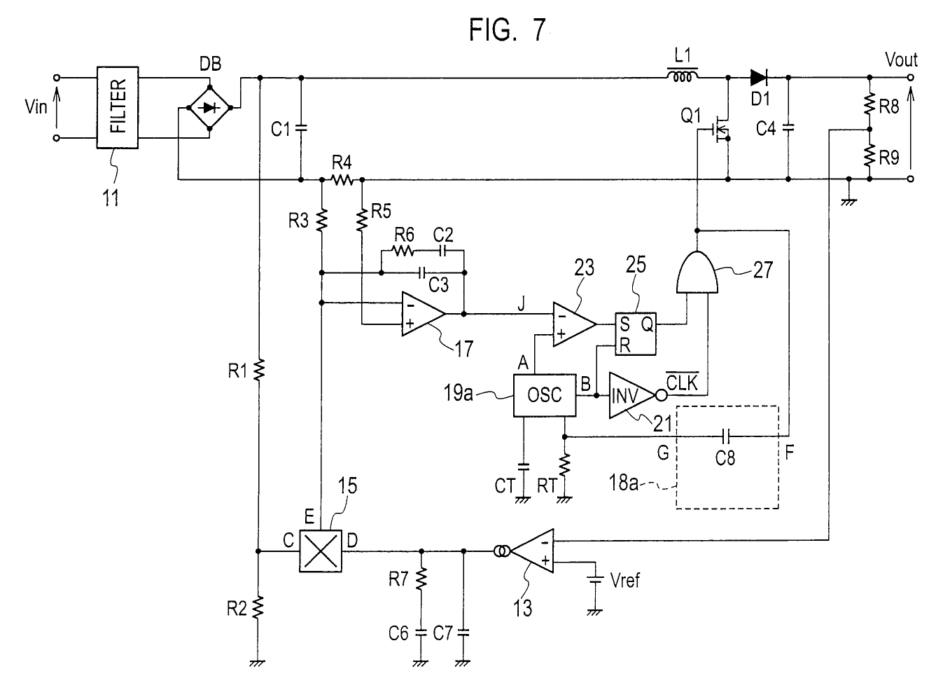

FIG. 7 is a circuit diagram illustrating a power factor correcting converter according to Embodiment 3 of the present invention. The present embodiment employs a smoothing circuit 18a composed of a capacitor C8 connected between the gate terminal of a switching element Q1, the output terminal of an AND gate 27, and a timing resistor RT of an oscillator 19a.

The smoothing circuit 18a of the present embodiment smoothes a control signal Q1g through the capacitor C8 and applies the smoothed signal to the timing resistor RT. The smoothing circuit 18a operates like the smoothing circuit 18 of Embodiment 1, and therefore, the power factor correcting converter of the present embodiment provides an effect similar to that provided by the power factor correcting converter of Embodiment 1.

The capacitor C8 may be connected to a timing capacitor CT instead of the timing resistor RT of the oscillator 19a.

The present invention is not limited to Embodiments 1 to 3. For example, the present invention may arrange a smoothing circuit composed of a first resistor connected between the gate terminal of the switching element Q1, the output terminal of the AND gate 27, and the timing resistor RT of the oscillator 19a.

This first resistor may be connected to the timing capacitor CT instead of the timing resistor RT of the oscillator 19a.

In summary, the smoothing circuit employed in the power factor correcting converter according to any one of the embodiments of the present invention smoothes a control signal supplied to a switching element, to obtain a DC voltage of a sinusoidal component of an input voltage. The obtained DC voltage is applied to a control signal generator. The DC voltage applied to the control signal generator varies, and therefore, the oscillation frequency of the control signal varies. This results in varying the switching frequency of the switching element within a predetermined range, to disperse frequency components of the switching frequency. This also disperses harmonics contained in the switching frequency. Consequently, the present invention can reduce noises at low cost and minimize losses.

This application claims benefit of priority under 35USC §119 to Japanese Patent Application No. 2008-013970, filed on Jan. 24, 2008, the entire content of which is incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A power factor correcting converter comprising:
a rectifier configured to rectify an AC voltage of an AC power source into a pulsating voltage;
a voltage converter having a switching element, configured to convert the pulsating voltage into a predetermined DC voltage by controlling the switching element according to a control signal;
a smoothing circuit configured to smooth the control signal; and
a control signal generator configured to generate the control signal and change a switching frequency of the control signal according to an output from the smoothing circuit.

2. The power factor correcting converter of claim 1, wherein
the smoothing circuit has at least one impedance element of a resistor or a capacitor.
